(19) United States
(12) Patent Application Publication
(10) Pub. No.: US 2016/0179302 A1
(43) Pub. Date: Jun. 23, 2016

(54) PHOTO SELECTION AND MANAGEMENT APPLICATION

(71) Applicant: SmugMug, Inc., Mountain View, CA (US)

(72) Inventors: Brian STRONG, San Jose, CA (US); Don MACASKILL, Los Altos, CA (US)

(21) Appl. No.: 14/964,311

(22) Filed: Dec. 9, 2015

Related U.S. Application Data
(60) Provisional application No. 62/094,803, filed on Dec. 19, 2014.

(51) Int. Cl. G06F 3/0482; G06F 3/0484

(52) U.S. Cl. CPC G06F 3/0482; G06F 3/04842

(57) ABSTRACT

The present disclosure generally relates to a software application platform which provides a user with the ability to review, manage, and store media items. An application, such as a website or mobile app, may provide a user, via a device connected with graphical user interface such as a desktop computer, set top box, smart phone, tablet, etc., the opportunity to classify and organize media items, such as but not limited to digital photographs. The user may additionally recall a media item for review, manage the media item by comparing the media item to other media items, and make a determination with respect to the media item.

### CROSS-REFERENCE TO RELATED APPLICATIONS

This application claims benefit to U.S. Provisional Patent Application No. 62/094,803, filed Dec. 19, 2014, the entirety of which is herein incorporated by reference.

### BACKGROUND

1. Field

Embodiments of the present disclosure generally relate to media item management and organization. More specifically, embodiments provided herein relate to applications for digital photo selection, management, and storage.

2. Description of the Related Art

The production and availability of information and media has gained prevalence in today's society. The ability to instantly access and share information, experiences, news, photos, and videos over the internet has revolutionized the way people connect, learn, consume information, and participate in society today.

The storage and accessing of files and media items often takes place in the cloud via a device connected to the internet. Remote servers, which make up the cloud, maintain and store files and media items; however, storage space comes with a premium cost. The ability to create multiple media items at any time or location around the globe also requires the ability to effectively and efficiently store and manage those media items. Furthermore, engaging a user to dedicate time to efficiently and effectively manage media items in storage requires a more in depth user media experience.

Therefore, what is needed in the art is a software application which integrates photo selection, management, and storage and provides users of the application with a more unique experience with respect to managing media items. More specifically, what is needed in the art is a photo selection and management application.

### SUMMARY

The present disclosure generally relates to a software application platform which provides a user with the ability to review, manage, and store media items. An application, such as a website or mobile app, may provide a user, via a device connected with a graphical user interface such as a desktop computer, set top box, smart phone, tablet, etc., the opportunity to classify and organize media items, such as but not limited to digital photographs. The user may additionally recall a media item for review, manage the media item by comparing the media item to other media items, and make a determination with respect to the media item.

In one embodiment, a method of organizing media content is provided. The method may include analyzing one or more metadata variables of a first plurality of media items. The method may further include determining, based on a prioritization of a first metadata variable, a display constraint characteristic. The method may also include selecting a second plurality of media items from the first plurality to be generated in response to the prioritization of the first metadata variable and the display constraint characteristic, generating an active cascade feature defined by the display constraint characteristic of the second plurality of media items, displaying the second plurality of media items in the active cascade feature, and/or displaying the second plurality of media items in a static cascade feature.

In another embodiment, a computer system for organizing media content is provided. The computer system for organizing media content may include a processor and a memory storing instructions that, when executed by the processor, may cause the computer system to analyze one or more metadata variables of a first plurality of media items. The computer system may also determine, based on a prioritization of a first metadata variable, a display constraint characteristic. The system may select a second plurality of media items from the first plurality to be generated in response to the prioritization of the first metadata variable and the display constraint characteristic, generate an active cascade feature defined by the display constraint characteristic of the second plurality of media items, display the second plurality of media items in the active cascade feature, and/or display the second plurality of media items in a static cascade feature.

In yet another embodiment, a non-transitory computer-readable storage medium, storing instructions that when executed by the processor, cause the processor to organize media content is provided. The processor may perform the steps of analyzing one or more metadata variables of a first plurality of media items. The processor may further perform the steps of determining, based on a prioritization of a first metadata variable, a display constraint characteristic, and selecting a second plurality of media items from the first plurality to be generated in response to the prioritization of the first metadata variable and the display constraint characteristic. The processor may also perform the steps of generating an active cascade feature defined by the display constraint characteristic of the second plurality of media items, displaying the second plurality of media items in the active cascade feature, and/or displaying the second plurality of media items in a static cascade feature.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a computer system configured for providing a website having a media item selection and management application according to one embodiment described herein.

FIG. 2 illustrates a more detailed view of a server of FIG. 1 according to one embodiment described herein.

FIG. 3 illustrates a user computing system used to access a website and utilize the media item selection and management application according to one embodiment described herein.

FIG. 4 schematically illustrates operations of a method to select and manage a media item according to one embodiment described herein.

FIG. 5 schematically illustrates operations of a method to select and manage a media item according to one embodiment described herein.

FIG. 6 illustrates an active cascade of media items displayed on a GUI of a mobile device according to one embodiment described herein.

FIG. 7 illustrates a static cascade of media items displayed on a GUI of a mobile device according to one embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to media item organization and management and an application which analyzes, determines, selects, generates, and displays media items individually or in a cluster based upon characteristics of each media item. For example, a device may store various digital photographs such that the digital photographs can be accessed by the device upon request by a user or an application. The application may automatically analyze the metadata of each digital photograph in order to determine a shared characteristic between similar media items. The application may provide for a media experience uniquely tailored to the subject matter, content, metadata, user, and/or location of the various media items.

The term “user” as used herein includes, for example, a person or entity that owns a computing device or wireless device; a person or entity that operates or utilizes a computing device or a wireless device; or a person or entity that is otherwise associated with a computing device or a wireless device. It is contemplated that the term “user” is not intended to be limiting and may include various examples beyond those described.

The term “media” or “media item” as used herein includes, for example, messages, photos, videos, audio, blogs, advertisements, geotags, notifications, and various other types of media which may be consumed by a user. It is contemplated that the terms “media” or “media item” are not intended to be limiting and may include various examples beyond those described.

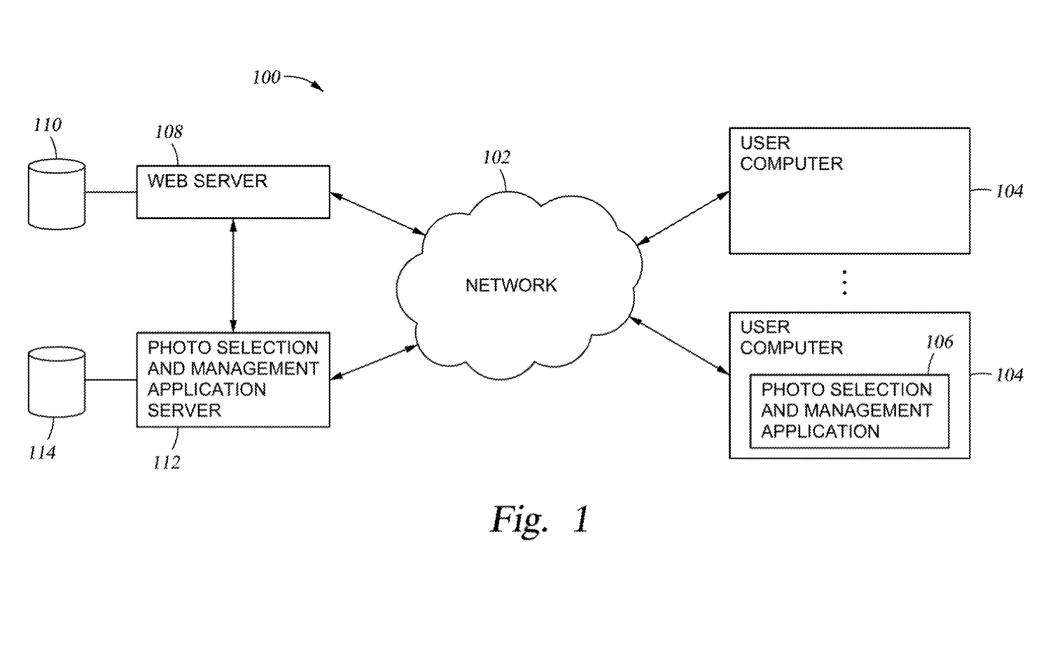

FIG. 1 illustrates a computer system 100 configured for providing a photo selection and management application 106. As shown, the computing system 100 may include a web server 108, a photo selection and management application server 112, and a plurality of user computers (i.e., mobile/wireless devices) 104 (only two of which are shown for clarity), each connected to a communications network 102 (e.g., the Internet). For example, the web server 108 may be programmed to communicate with the user computers 104 and the photo selection and management application server 112 using a networking protocol such as TCP/IP protocol. The photo selection management application server 112 may communicate directly with the user computers 104 through the communications network 102.

Each user computer 104 may include conventional components of a computing device, e.g., a processor, system memory, a hard disk drive, a battery, input devices such as a mouse and a keyboard, and/or output devices such as a monitor or graphical user interface (GUI), and/or a combination input/output device such as a touchscreen which not only receives input but also displays an output. The web server 108 and the photo selection and management application server 112 may include a processor and a system memory (not shown), and may be configured to manage media content stored in its respective content storage unit 110 and 114, respectively, using a file system and/or relational database software. The photo selection and management application server 112 may be configured to receive input from a user, such as selecting, organizing, and managing media items.

In the embodiments described below, users are respectively operating the user computers 104 that may communicate over the network 102 to request media from the photo selection and management application server 112. Each user computer 104 may be configured to execute a software application, such as the photo selection and management application 106, and access media managed by the photo selection and management application server 112. The media displayed to a user may be transmitted from the photo selection and management application server 112 to the user's computer 104 and processed by the photo selection and management application 106 for display through a GUI of the user's computer 104.

In one example, media displayed on the user's computer 104 may be a plurality of media items generated by the user and associated with various geographical locations, times, subjects, or other metadata descriptors. The user's computer 104 may access the photo selection and management application server 112 which, in turn, retrieves the user's media items from a storage location (not shown) associated with the user computer 104 and causes the user's media items to be displayed through the photo selection and management application 106 on the GUI of the user's computer when the user prompts the photo selection and management application 106 to open and run. The user's media items may be managed by the user with a username and password combination, or other similar restricted access/verification required access methods, which allow the user to “log in” and make changes to the media item. Decisions made by the user to their media items on the user computer 104 may be transmitted through the communications network 102 to the photo selection and management application server 112. The photo selection and management application server 112 may transfer the user's media item to storage 114 where it may be retrieved and viewed by the user or another user at any time.

In another example, media items displayed on a user's computer 104 may be media items associated with a particular geographical location created by the user of the photo selection and management application 106. The user's computer 104 may access the photo selection and management application server 112, which, in turn, accesses and retrieves the user's media items from user computer's storage (not shown), and causes the user's media items to be displayed through the photo selection and management application 106 on a GUI of the user's computer 104.

It is noted that the user computer 104 may be a personal computer, laptop, mobile computing device, smart phone, video game console, home digital media player, network-connected television, set top box, and/or other computing devices having components suitable for communicating with the communications network 102. The user computer 104 may also execute other software applications configured to receive media content and photo selection and management information from the photo selection and management application server 112, such as, but not limited to, location based services, media display software, media players, computer and video games, and/or widget platforms, among others.

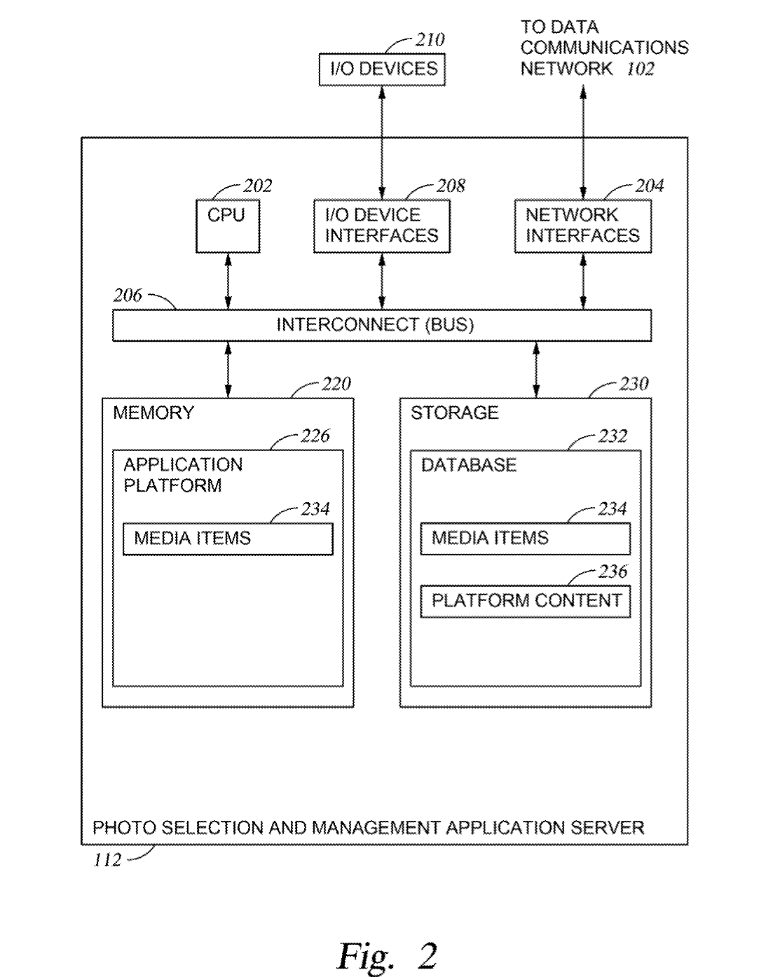

FIG. 2 illustrates a more detailed view of the photo selection and management application server 112 of FIG. 1. The photo selection and management application server 112 includes, without limitation, a central processing unit (CPU) 202, a network interface 204, memory 220, and storage 230 communicating via an interconnect bus 206. The photo selection and management application server 112 may also include I/O device interfaces 208 connecting I/O devices 210 (e.g., keyboard, video, mouse, audio, touchscreen, etc.). The photo selection and management application server 112 may further include the network interface 204 configured to transmit data via the communications network 102.

The CPU 202 retrieves and executes programming instructions stored in the memory 220 and generally controls and coordinates operations of other system components. Similarly, the CPU 202 stores and retrieves application data residing in the memory 220. The CPU 202 is included to be representative of a single CPU, multiple CPU's, a single CPU having multiple processing cores, and the like. The interconnect 206 is used to transmit programming instructions and application data between the CPU 202, I/O device interfaces 208, storage 230, network interface 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disk drives, floppy disk drives, hard disk drives, flash memory storage drives, tape drives, removable memory cards, CD-ROM, DVD-ROM, Blu-Ray, HD-DVD, optical storage, network attached storage (NAS), cloud storage, or a storage area-network (SAN) configured to store non-volatile data.

The memory 220 may store instructions and logic for executing an application platform 226. The storage 230 may store media items 234 and other user generated media and may include a database 232 configured to store media items 234 associated with specific metadata and application platform content 236. The database 232 may also store application content relating to metadata associated with user generated media and other application features for providing the user with an application platform that displays media items 234 based upon the metadata associated with various media items 234. The database 232 may be any type of storage device.

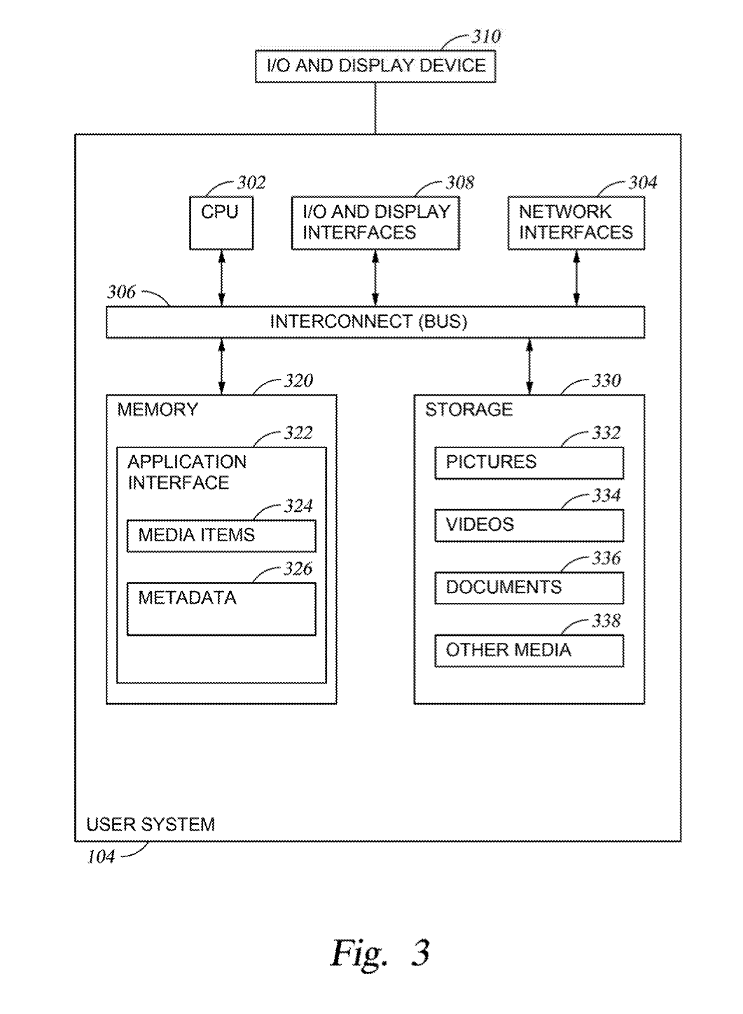

FIG. 3 illustrates a user computing system 104 used to access the photo selection and management application server 112 and display media associated with the application platform 226. The user computing system 104 may include, without limitation, a central processing unit (CPU) 302, a network interface 304, an interconnect 306, a memory 320, and storage 330. The computing system 104 may also include an I/O device interface 308 connecting I/O devices 310 (e.g., keyboard, display, touchscreen, and mouse devices) to the computing system 104.

Like CPU 202, CPU 302 is included to be representative of a single CPU, multiple CPUs, a single CPU having multiple processing cores, etc., and the memory 320 is generally included to be representative of a random access memory. The interconnect 306 may be used to transmit programming instructions and application data between the CPU 302, I/O device interfaces 308, storage 330, network interface 304, and memory 320. The network interface 304 may be configured to transmit data via the communications network 102, e.g. to stream content from the photo selection and management application server 112. Storage 330, such as a hard disk drive or solid-state storage drive (SSD), may store non-volatile data. The storage 330 may contain pictures 332, videos 334, documents 336, and other media 338 which can be any type of media that may be uploaded to the photo selection and management application 106. Illustratively, the memory 320 may include an application interface 322, which itself may display media items 324, and/or store metadata 326 of media items 324. The application interface 322 may provide one or more software applications which allow the user to access media items and other content hosted by the photo selection and management application server 112.

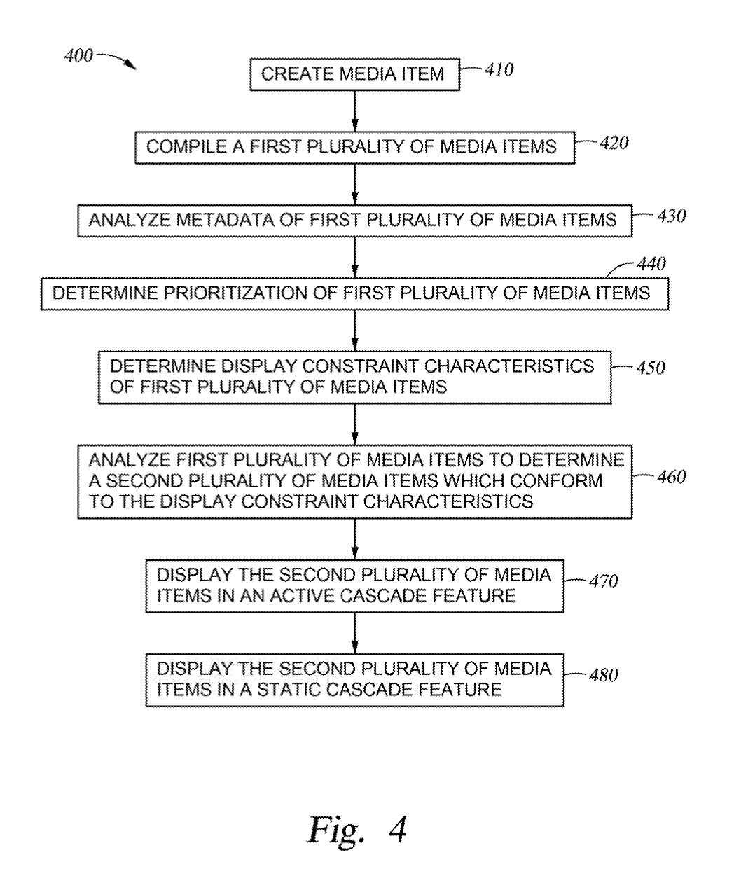

FIG. 4 schematically illustrates operations of a method 400 to select and manage a media item according to one embodiment described herein. The media item may be associated with various metadata. For example, one or more metadata variables may be associated with the media item at the time of generation of the media item or subsequent to generation of the media item. At operation 410, a media item is created. The creation of a media item may include, but is not limited to, taking a photograph, drafting a document, creating an audio file, and the like, and storing the media item on the user computer 104. The media item may be created by a user of the photo selection and management application 106. Upon a user request to access the photo selection and management application 106, the photo selection and management application 106 may access the media items stored on the user computer 104 and may associate, store, or compile all accessed media items together into a first plurality of media items within the photo selection and management application 106 as shown at operation 420. Each media item may have metadata associated with the media item that may also be accessible by the photo selection and management application 106. The metadata associated with each media item may generally include, but is not limited to, the means of creation of the data, the purpose of the data, the time and date of creation of the data, the creator or author of the data, the geographical location where the data was captured, the location on a computer network where the data was created, the standards used, file size of the data, the color depth, the image resolution, etc.

At operation 430, the photo selection and management application 106 may analyze the metadata of the first plurality of media items. Analyzing the metadata of the first plurality of media items may allow the photo selection and management application 106 to search for and find commonalities between the media items. Such commonalities may include, but are not limited to, similar geographical locations at which media items within the first plurality of media items were created, a close proximity of time in which the media items within the first plurality of media items were created, similar subject matters of the media items within the first plurality of media items, similar purposes for the creation of the media items within the first plurality of media items, etc. At least one commonality in metadata may be shared between the first plurality of media items or a subset of media items within the first plurality of media items. Based on the commonalities shared, at operation 440, a prioritization of the first plurality of media items is made or selected. The prioritization may be based upon at least one commonly shared metadata item, for example, the time the media item was created.

By example, for purposes of illustration only and without limitation, multiple digital photographs may be taken on a particular day. However, several of the digital photographs may have been taken at or around a specific time on the particular day. Upon launch, the photo selection and management application 106 may compile the digital photographs taken on the particular day as in operation 420, and analyze the metadata of each photograph as in operation 430. The photo selection and management application 106 may further determine from the metadata information that several of the digital photographs were taken within the three o'clock hour. Based on this metadata information, a prioritization of the digital photographs has been determined as in operation 440; in this example, a time metadata variable.

At operation 450, the photo selection and management application 106 may determine a display constraint characteristic of the first plurality of media items. The display constraint characteristic may relate to or be based upon the prioritization selected at operation 440. The display constraint characteristic may be a narrower subset of the prioritization or may limit the prioritization selected by the photo selection and management application 106. Based upon the display constraint characteristic determined by the photo selection and management application 106, the first plurality of media items may be analyzed to determine a second plurality of media items which conform to the display constraint characteristic as illustrated in operation 460.

By continued example, for purposes of illustration only and without limitation, the display constraint characteristic of operation 450 may be a subset of the prioritization of operation 440. Based on the prioritization determined—in this example, time—a display constraint characteristic that further limits the first plurality of media items may be a certain time range; for example, digital photographs taken between 3:00 PM and 3:10 PM on the particular day. As in the operation at 460, the photo selection and management application 106 may analyze the metadata of the first plurality of digital photographs for digital photographs that conform to the display constraint characteristic of operation 460. In the present example, those digital photographs taken between the time constraint selected, i.e. between 3:00 PM and 3:10 PM. The photo selection and management application 106 may select those digital photographs which conform to the display constraint characteristic, thus creating a second plurality of digital photographs.

At operation 470, the photo selection and management application 106 may display the second plurality of media items in an active cascade feature on a GUI of the user computer 104. The active cascade feature may rotate through the second plurality of media items, for example, in the form of a slideshow. The active cascade feature may display each media item on the GUI of the user computer 104 for between approximately 0.5 seconds and approximately 20 seconds such that a user may closely examine the media items in a rapid succession display and determine the differences between the media items. The active cascade feature may rotate through each media item comprising the second plurality of media items one or more times before ending the active cascade feature. The active cascade feature may further individually display or display as a group each media item of the second plurality of media items on the GUI of the user computer 104.

At operation 480, the photo selection and management application 106 may display the second plurality of media items in a static cascade feature on a GUI of the user computer 104. The static cascade feature may display the second plurality of media items together, concurrently, on the GUI of the user computer 104. The static cascade feature may allow for a user to select one or more of the media items of the second plurality of media items and the photo selection and management application 106 may provide the option to save, move, delete, and/or store any media item of the second plurality.

By continued example, for purposes of illustration only and without limitation, the photo selection and management application 106 may display the second plurality of digital photographs in an active cascade feature, as in operation 470. The active cascade feature of operation 470 may digitally flip through each digital photograph of the second plurality one at a time on the GUI of the user computer 104, such that each digital photograph may be displayed individually, one at a time. The active cascade feature of operation 470 may assist a user with recognizing flaws in the media item such as blurred images, excess quantity of specific images, or poorly executed digital photographs. The static cascade of operation 480 may display the second plurality of digital photographs on the GUI of the user computer 104 side-by-side such that the user can make determinations with respect to each digital photograph, such determinations including whether to save, move, delete, and/or store the digital photograph to or with the photo selection and management application 106.

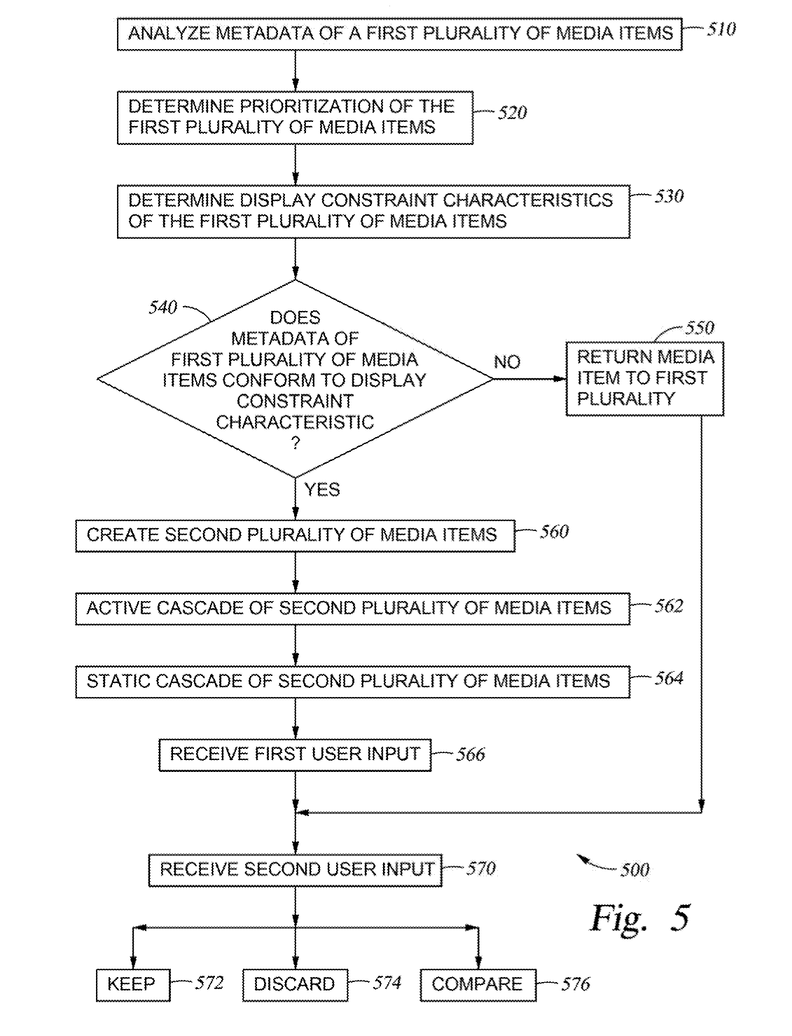

FIG. 5 schematically illustrates operations of a method 500 for determining the display constraint characteristic of the first plurality of media items according to one embodiment described herein. The method 500 generally relates to embodiments wherein the photo selection and management application 106 is determining the display constraint characteristic, based on the prioritization, in order to further separate the first plurality of media items into one of the first plurality of media items or the second plurality of media items. At operation 510, the photo selection and management application 106 may analyze the metadata of the first plurality of media items. Analyzing the metadata of the first plurality of media items may allow the photo selection and management application 106 to search for and find commonalities between the media items. Such commonalities may include, but are not limited to, similar geographical locations at which media items within the first plurality of media items were created, a close proximity of time in which the media items within the first plurality of media items were created, similar subject matters of the media items within the first plurality of media items, similar purposes for the creation of the media items within the first plurality of media items, etc. At least one commonality in metadata may be shared between the first plurality of media items or a subset of media items within the first plurality of media items. Based on the commonalities shared, at operation 520, a prioritization of the first plurality of media items is made or selected. The prioritization may be based upon at least one commonly shared metadata item; for example, the time the media item was created.

At operation 530 the display constraint characteristic of the first plurality of media items is determined. The display constraint characteristic may relate to or be based upon the prioritization selected at operation 520. The display constraint characteristic may be a narrower subset of the prioritization or may limit the prioritization selected by the photo selection and management application 106. Based upon the display constraint characteristic determined by the photo selection and management application 106 the first plurality of media items may be analyzed to determine a second plurality of media items which conform to the display constraint characteristic as illustrated in operation 540. If the determination made in operation 540 indicates that the metadata of a media item within the first plurality of media items conforms to the display constraint characteristic of operation 530, the media item may be categorized into a created second plurality of media items at operation 560. All media items within the determination made in operation 540 which conform to the display constraint characteristic of operation 530 may be categorized into the created second plurality of media items at operation 560.

The second plurality of media items created at operation 560 may be displayed in the active cascade feature on the GUI of the user computer 104 as illustrated in operation 562. The active cascade feature may rotate through the second plurality of media items, displaying each media item of the second plurality of media items on the GUI of the user computer 104 for between approximately 0.5 seconds and approximately 20 seconds such that a user may closely examine the media items in a rapid succession display and determine the differences between the media items. The active cascade feature may rotate through each media item comprising the second plurality of media items one or more times before ending the active cascade feature. The active cascade feature may further individually display or display as a group each media item of the second plurality of media items on the GUI of the user computer 104. At operation 564, the photo selection and management application 106 may display the second plurality of media items in a static cascade feature on a GUI of the user computer 104. The static cascade feature may display the second plurality of media items together, concurrently, on the GUI of the user computer 104.

The static cascade feature of operation 564 may allow for a user to select one or more of the media items of the second plurality of media items and the photo selection and management application may provide the option to receive a first user input as in the operation at 566. The first user input, as in the operation at 566, may allow for a user to select one or more of the media items from the second plurality of media items and subsequently allow the photo selection and management application 106 to receive an instruction relating to the storage of the selected media item from the second plurality of media items. The operation at 566 may be repeated for each media item of the second plurality of media items. In one embodiment, the input received by the photo selection and management application 106 may store the media item of the second plurality of media items selected and may discard the other media items of the second plurality of media items.

At operation 570, the photo selection and management application 106 may continue to display on a GUI of the user computer 104 the first plurality of media items, as well as receive a second user input relating to each media item of the first plurality of media items displayed on the GUI. The photo selection and management application 106 may receive a second user input instructing the photo selection and management application 106 to keep and/or store the media item in operation 572, discard the media item in operation 574, and/or compare the media item in operation 576.

If the determination made in operation 540 indicates that the metadata of a media item of the first plurality of media items does not conform to the display constraint characteristic of the operation at 530, the media item may be returned to the first plurality of media items as illustrated in operation 550. The photo selection and management application 106 may receive a second user input instructing the photo selection and management application 106 to keep and/or store the media item in operation 572, discard the media item in operation 574, and/or compare the media item in operation 576.

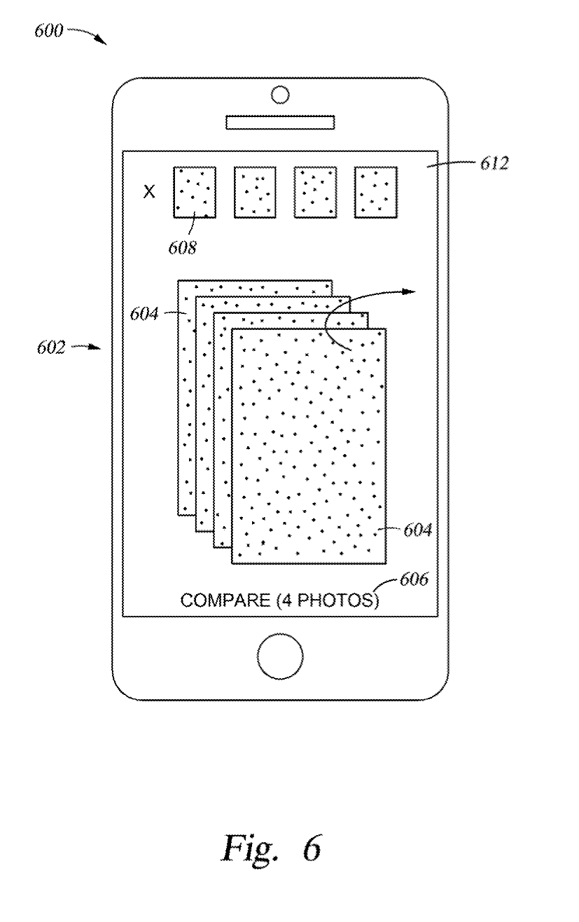

FIG. 6 illustrates the photo selection and management application 106 displayed on a GUI 602 of a mobile device 600. An interface 612 of the photo selection and management application 106 may be displayed in various manners. As depicted, the interface 612 is displayed in the GUI 602 as an arrangement of digital photos 604 in an active cascade feature. The digital photos 604 may also be displayed in a list type format or other type format such that a user may determine how and where to store, and/or to discard, and/or to compare the multiple digital photos.

The active cascade feature may rotate through the plurality of media items, displaying each media item of the plurality of media items on the GUI 602 of the user computer 600, a mobile device in this embodiment, for between approximately 0.5 seconds and approximately 20 seconds. During the active cascade a user may closely examine the media items in a rapid succession display to determine the differences between the media items. The active cascade feature may rotate through each media item comprising the plurality of media items one or more times before ending the active cascade feature. The active cascade feature may further individually display or display as a group each media item of the plurality of media items on the GUI 602 of the mobile device 600. An instruction 606 may be displayed on the GUI 602 of the mobile device 600 which may instruct the user to perform a task relating to the media items. As illustrated in FIG. 6, the instruction 606 directs the user to “COMPARE (4 PHOTOS)” of the active cascade. Upon comparing the media items of the active cascade feature the mobile device 600 may receive an input from the user which instructs the mobile device 600 to keep, discard, and/or compare the selected media item. Media items with instructions to the mobile device 600 to keep and/or store the media item may be transferred to a second location 608 on the GUI 602 of the mobile device 600.

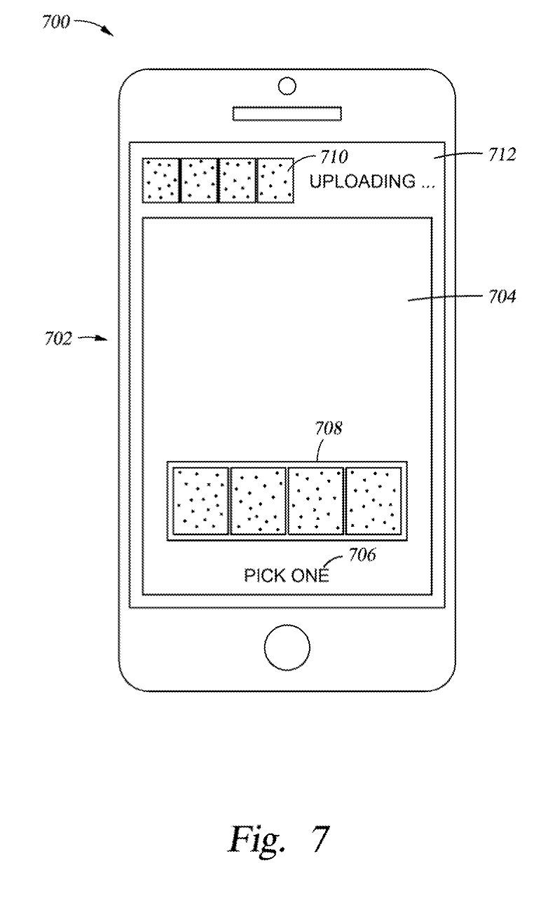

FIG. 7 illustrates the photo selection and management application 106 displayed on a GUI 702 of a mobile device 700. An interface 712 of the photo selection and management application 106 may be displayed in various manners. As depicted, the interface 712 is displayed in the GUI 702 as a single digital photo 704 in a static cascade feature. The digital photo 704 may also be displayed in a list type format or other type format such that a user may determine how and where to store, and/or to discard, and/or to compare the digital photos of the static cascade.

The static cascade feature may display the media items of the active cascade in an arrangement such that the media items of the active cascade are concurrently displayed in a cluster on the GUI 702 of the user computer 700, a mobile device in this embodiment, until the user computer 104 receives an input from the user. The static cascade feature may allow a user to view each of the media items together as a grouping or cluster 708. In one example, the media items included in the cluster 708 may be the digital photos 604 displayed in the active cascade feature described with regard to FIG. 6. An instruction 706 may be displayed on the GUI 702 of the mobile device 700 which may instruct the user to perform a task relating to the media items. As illustrated in FIG. 7, the instruction 706 directs the user to “PICK ONE” media item of the static cascade. Upon displaying the media items of the static cascade feature the mobile device 700 may receive an input from the user which instructs the mobile device 700 to keep, discard, and/or compare the selected media item. Media items with instructions to the mobile device 700 to keep and/or store the media item may be transferred to a second location 710 on the GUI 702 of the mobile device 700.

The effective and efficient storage, management, and accessing of files and media items is disclosed herein, in order to reduce the costs associated with media item storage. With the disclosed Photo Selection and Management Application, a user is able to effectively and efficiently manage, store, and access media items via a device connected to the internet. Efficient management includes reduced media item storage costs via an application that engages a user to dedicate time to efficiently and effectively manage media items in and out of storage. Therefore, a software application is disclosed which integrates photo selection, management, and storage and provides users of the application with a more unique experience with respect to managing media items. Specifically, the present disclosure generally relates to a software application platform which provides a user with the ability to review, manage, and store media items. An application, such as a website or mobile app, may provide a user, via a device connected with a graphical user interface such as a desktop computer, set top box, smart phone, tablet, etc., the opportunity to classify and organize media items, such as but not limited to digital photographs. The user may additionally recall a media item for review, manage the media item by comparing the media item to other media items, and make a determination with respect to the media item

While the foregoing is directed to embodiments described herein, other and further embodiments may be devised without departing from the basic scope thereof. For example, aspects of the present disclosure may be implemented in hardware or software or in a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the disclosed embodiments, are embodiments of the present disclosure. Therefore, the scope of the embodiments provided herein is determined by the claims that follow.

What is claimed is:

1. A method of organizing media content, comprising:
analyzing one or more metadata variables of a first plurality of media items;
determining, based on a prioritization of a first metadata variable, a display constraint characteristic;
selecting a second plurality of media items from the first plurality to be generated in response to the prioritization of the first metadata variable and the display constraint characteristic;
generating an active cascade feature defined by the display constraint characteristic of the second plurality of media items;
displaying the second plurality of media items in the active cascade feature; and
displaying the second plurality of media items in a static cascade feature.

2. The method of claim 1, wherein the media items are digital photographs.

3. The method of claim 1, wherein the display constraint characteristic is a subclass of the prioritization of the first metadata variable.

4. The method of claim 1, wherein the active cascade feature is a sequential arrangement of the second plurality of media items displayed one media item of the second plurality of media items at a time, in succession, each media item being displayed for between about 0.5 seconds and about 15 seconds.

5. The method of claim 1, wherein the static cascade feature is an arrangement of the second plurality of media items, and wherein the second plurality of media items are concurrently displayed in a cluster.

6. The method of claim 1, wherein the second plurality of media items are displayed in the active cascade feature before the second plurality of media items are displayed in the static cascade feature.

7. The method of claim 1, wherein the second plurality of media items of the active cascade feature and the second plurality of media items of the static cascade feature maintain at least one display constraint characteristic in common.

8. The method of claim 1, wherein an input is received from a user by selecting one or more media items, the input determining a storage location for the media item, and the input comprising at least one of:
keeping the media item;
discarding the media item; and
comparing one or more media items.

9. A computer system for organizing media content, comprising:
a processor; and
a memory storing instructions that, when executed by the processor, cause the computer system to:
analyze one or more metadata variables of a first plurality of media items;
determine, based on a prioritization of a first metadata variable, a display constraint characteristic;
select a second plurality of media items from the first plurality to be generated in response to the prioritization of the first metadata variable and the display constraint characteristic;
generate an active cascade feature defined by the display constraint characteristic of the second plurality of media items;
display the second plurality of media items in the active cascade feature; and
display the second plurality of media items in a static cascade feature.

10. The computer system of claim 9, wherein the media items are digital photographs.

11. The computer system of claim 9, wherein the display constraint characteristic is a subclass of the prioritization of the first metadata variable.

12. The computer system of claim 9, wherein the active cascade feature is a sequential arrangement of the second plurality of media items displayed one media item of the second plurality of media items at a time, in succession, each media item being displayed for between about 0.5 seconds and about 15 seconds.

13. The computer system of claim 9, wherein the static cascade feature is an arrangement of the second plurality of media items, and wherein the second plurality of media items are concurrently displayed in a cluster.

14. The computer system of claim 9, wherein the second plurality of media items are displayed in the active cascade feature before the second plurality of media items are displayed in the static cascade feature.

15. The computer system of claim 9, wherein the second plurality of media items of the active cascade feature and the second plurality of media items of the static cascade feature maintain at least one display constraint characteristic in common.

16. The computer system of claim 9, wherein an input is received from a user by selecting one or more media items, the input determining a storage location for the media item, and the input comprising at least one of:
keeping the media item;
discarding the media item; and
comparing one or more media items.

17. A non-transitory computer-readable storage medium, storing instructions that when executed by the processor, cause the processor to organize media content, by performing the steps of:
analyzing one or more metadata variables of a first plurality of media items;
determining, based on a prioritization of a first metadata variable, a display constraint characteristic;
selecting a second plurality of media items from the first plurality to be generated in response to the prioritization of the first metadata variable and the display constraint characteristic;
generating an active cascade feature defined by the display constraint characteristic of the second plurality of media items;
displaying the second plurality of media items in the active cascade feature; and
displaying the second plurality of media items in a static cascade feature.

18. The method of claim 17, wherein the media items are digital photographs.

19. The method of claim 17, wherein the display constraint characteristic is a subclass of the prioritization of the first metadata variable.

20. The method of claim 17, wherein the active cascade feature is a sequential arrangement of the second plurality of media items displayed one media item of the second plurality of media items at a time, in succession, each media item being displayed for between about 0.5 seconds and about 15 seconds.

21. The method of claim 17, wherein the static cascade feature is an arrangement of the second plurality of media items, and wherein the second plurality of media items are concurrently displayed in a cluster.

22. The method of claim 17, wherein the second plurality of media items are displayed in the active cascade feature before the second plurality of media items are displayed in the static cascade feature.

23. The method of claim 17, wherein the second plurality of media items of the active cascade feature and the second plurality of media items of the static cascade feature maintain at least one display constraint characteristic in common.

24. The method of claim 17, wherein a recurring input is received from a user by selecting one or more media items, the input determining a storage location for the media item, and the input comprising at least one of:
keeping the media item;
discarding the media item; and
comparing one or more media items.
